(19) United States
(12) Patent Application Publication
(10) Pub. No.: US 2026/0089419 A1
(43) Pub. Date: Mar. 26, 2026

(54) SOUND-RECEIVING STRUCTURE

(71) Applicant: OPEN ROAD SOLUTIONS, INC., Hsinchu City (TW)

(72) Inventor: CHING-TSAI CHOU, Hsinchu City (TW)

(73) Assignee: OPEN ROAD SOLUTIONS, INC., Hsinchu City (TW)

(21) Appl. No.: 18/953,869

(22) Filed: Nov. 20, 2024

(30) Foreign Application Priority Data
Sep. 27, 2024 (TW) 113137034

(51) Int. Cl. H04R 1/08

(52) U.S. Cl. CPC H04R 1/08

(57) ABSTRACT

A sound-receiving structure with wind noise resistance functionality comprises an outer shell having at least one sound inlet aperture. Inside the outer shell has at least one chamber in communication with the sound inlet aperture, and each chamber contains a porous body. The outer shell also includes at least one sound passage that connects the chamber to at least one microphone unit. The cross-sectional area of the sound passage is smaller than that of the chamber. When external sound passes through the sound inlet aperture and the chamber to the microphone unit, the porous body inside the chamber and the sound passage can significantly and effectively reduce wind noise interference, thereby maintaining the sound quality of the microphone. This structure is also more suitable for multiple microphone unit setups, allowing the number of chambers and passages to be adjusted as required.

### FIELD OF INVENTION

The present invention relates to a sound-receiving structure, in particular a sound-receiving structure with wind noise resistance.

### BACKGROUND OF THE INVENTION

With existing technology, microphone devices often face challenges such as wind noise and water ingress, especially in outdoor applications. Traditional approaches typically involve covering the microphone surface with sound-resistant materials, such as sponge, to reduce wind noise. Sponge typically has a honeycomb structure with high-density cavities that effectively mitigate low-frequency air vibrations, reducing the impact of wind noise on sound reception. However, this sponge often bulky and takes up significant space, which limits its application in miniaturized microphone devices. Moreover, due to the water-absorbing nature of the sponge, it absorbs moisture when exposed to rain or humid environments, causing its honeycomb structure to degrade and lose its wind noise reduction function. Additionally, the use of high-density sponge to cover the microphone surface makes it difficult to precisely control the dimensions during installation, resulting in potential gaps. These gaps allow airflow to pass through, generating unwanted noise and further compromising sound quality.

### SUMMARY OF THE INVENTION

In view of this, the present invention provides a sound-receiving structure connected to at least one microphone unit. This sound-receiving structure comprises an outer shell having: at least one sound inlet aperture, located on the upper surface of the outer shell; at least one chamber, situated inside the outer shell and in communication with the sound inlet aperture; at least one porous body, placed inside the at least one chamber; and at least one sound passage, used to connect the at least one microphone unit with the at least one chamber, wherein the cross-sectional area of the at least one sound passage is smaller than that of the at least one chamber.

Wherein the volume of the at least one porous body is substantially equal to the volume of the at least one chamber.

Wherein the porous bodies are made of foam, sponge, or other sound-resistant materials.

Wherein the interior of the at least one chamber is also equipped with a water-resistant breathable filter, positioned on the side of the at least one sound inlet aperture and tightly attached to the at least one porous body.

Wherein the at least one sound passage is equipped with a dust-proof component on one side and is tightly attached to the porous body inside the at least one chamber.

Wherein the number of the at least one sound inlet aperture is greater than or equal to the number of the at least one chamber.

Wherein the number of the at least one chamber is two, and the chambers are connected to each other through at least one connecting passage.

### BRIEF DESCRIPTION OF THE DRAWINGS

FIGS. 1 to 6 are schematic diagrams of the first to sixth embodiments of the sound-receiving structure of the present invention.

### DETAILED DESCRIPTION OF THE PREFERRED EMBODIMENTS

To offer a more comprehensive and detailed description of this disclosure, the following explanations are provided regarding the application and specific embodiments of the present invention. However, these descriptions are not intended to limit the scope of the present invention. Other embodiments may be employed to achieve the same or equivalent functions.

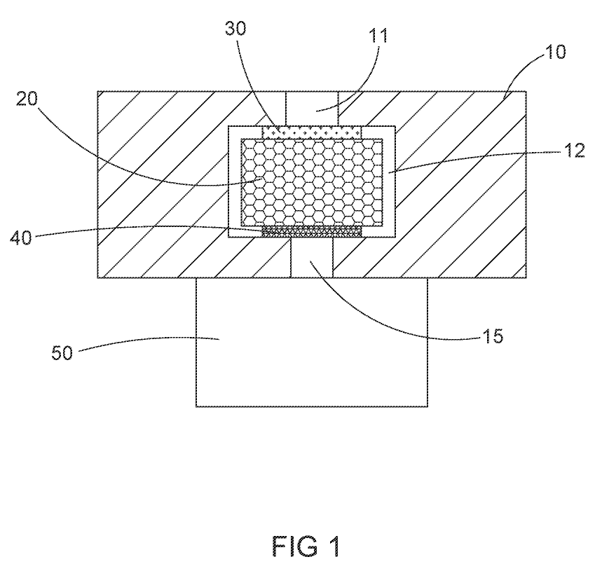

Referring to FIG. 1, the first embodiment of the sound-receiving structure of the present invention is illustrated. This sound-receiving structure is connected to a microphone unit 50 and includes an outer shell 10. The outer surface of the outer shell 10 has a sound inlet aperture 11 for receiving external sounds. Inside the outer shell 10 is a first chamber 12 that houses a porous body 20 for filtering wind noise. The first chamber 12 is in communication with the sound inlet aperture 11 and is connected to the microphone unit 50 through a sound passage 15. Notably, the present invention utilizes the larger cross-sectional area of the first chamber 12 relative to the sound passage 15 to effectively minimize airflow noise and enhance the overall noise reduction effect.

Furthermore, the volume of the porous body 20 is designed to closely match that of the first chamber 12, allowing the porous body 20 to be precisely sized to fill the first chamber 12 and prevent any gaps that could result in abnormal sounds due to airflow. The porous body 20 is made of a sound-resistant material which may include, but is not limited to, high-density porous foam or sponge.

To provide water and dust resistance for the sound-receiving structure, the interior of the first chamber 12 is equipped with a water-resistant breathable filter 30 and a dust-proof component 40. The water-resistant breathable filter 30 is tightly adhered to the sound inlet aperture 11, preventing rain or moisture from entering the first chamber 12, thereby protecting the porous body 20 from water damage that could compromise its noise reduction performance. The dust-proof component 40 is tightly attached to the entrance of the sound passage 15, thereby preventing small debris and dust from entering the microphone unit 50. Since the porous body 20 is tightly attached to both the water-resistant breathable filter 30 and the dust-proof component 40, ensuring that external sounds are filtered for moisture by the water-resistant breathable filter 30 before passing through the porous body 20, and further filtered for dust and debris by the dust-proof component 40 before reaching the microphone unit 50, thereby achieving overall noise reduction, waterproofing, and dust-proofing effects.

In this embodiment, the water-resistant breathable filter 30 is made of polytetrafluoroethylene, polyurethane, or expanded polytetrafluoroethylene, while the dust-proof component 40 is made of non-woven fabric, nylon, or polyester fiber. However, these materials are not limited to those mentioned, and other materials can be used to achieve the same effect.

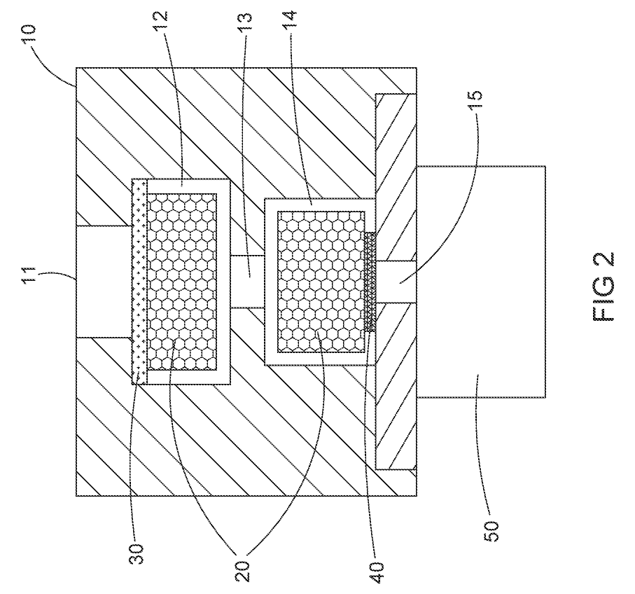

In addition to a single chamber, the sound-receiving structure of the present invention may include multiple chambers to further enhance the noise reduction effects. Referring to FIG. 2, which illustrates the second embodiment of the present invention, the interior of the outer shell 10 further includes a second chamber 14 which is similarly equipped with a porous body 20. When external sound enters the first chamber 12 through the sound inlet aperture 11, it undergoes a first round of noise filtering. The second chamber 14 located below the first chamber 12 is connected to each other through a connecting passage 13, and when the sound that has undergone the first round of noise filtering enters the second chamber 14 through the connecting passage 13, it is subjected to a second round of filtering. The second chamber 14 is connected to the microphone unit 50 through the sound passage 15, allowing the sound after the second round of noise filtering to be transmitted to the microphone unit 50. The cross-sectional area of the second chamber 14 is also larger than that of the sound passage 15, thus providing the same airflow noise elimination function.

In this embodiment, the water-resistant breathable filter 30 and the dust-proof component 40 are placed inside the first chamber 12 and the second chamber 14, respectively. The porous body 20 in the first chamber 12 is tightly attached to the water-resistant breathable filter 30, while the porous body 20 in the second chamber 14 is tightly attached to the dust-proof component 40. As in the previous embodiment, the water-resistant breathable filter 30 is tightly adhered to the sound inlet aperture 11 to prevent rain or moisture from entering the first chamber 12, while the dust-proof component 40 is tightly attached to the entrance of the sound passage 15 to prevent small debris and dust from reaching the microphone unit 50. The addition of the second chamber 14 further enhances the overall noise reduction effect.

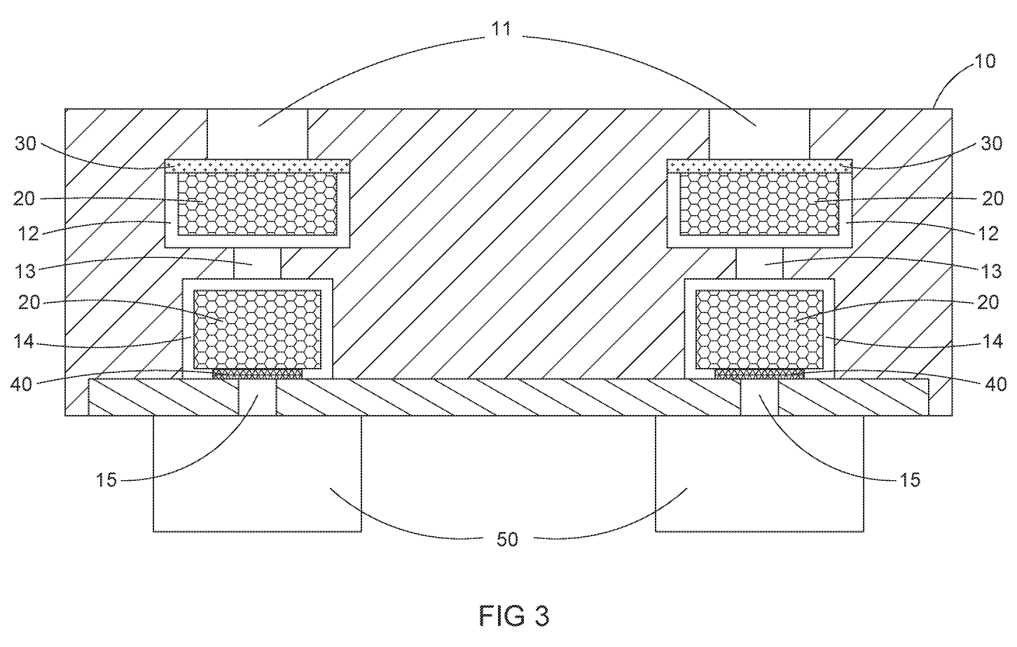

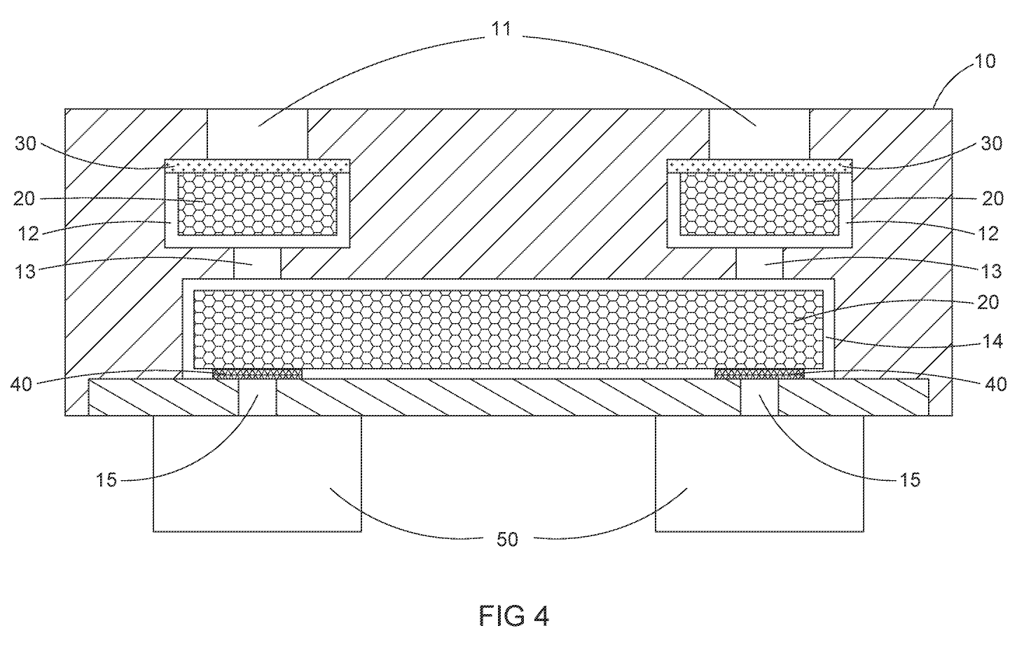

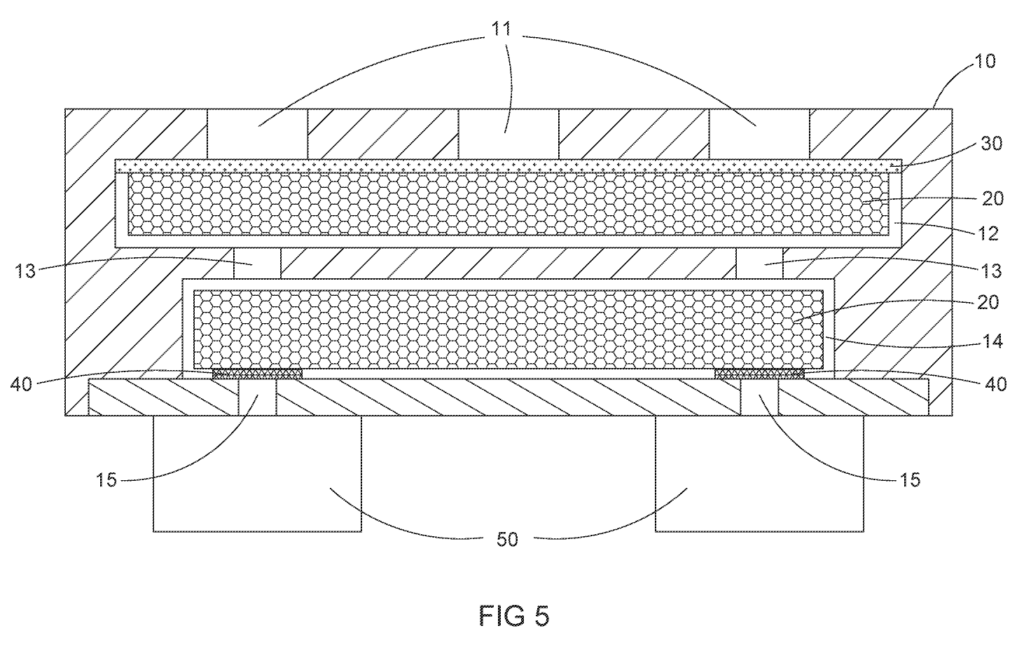

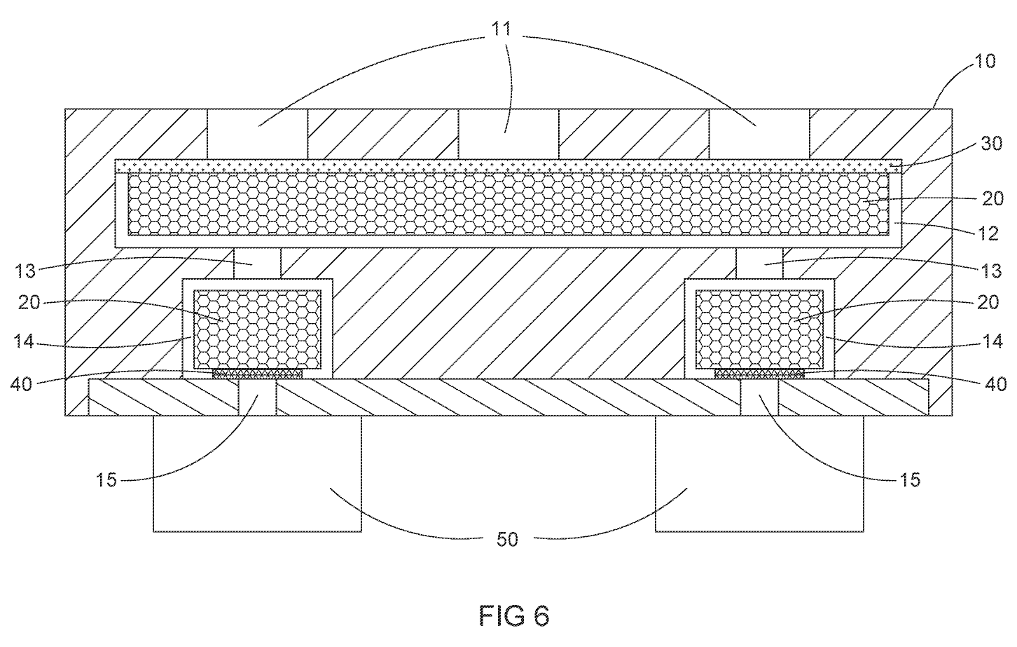

To enable the present invention to be applied to various devices and to meet different requirements, additional embodiments based on modifications of the second embodiment are described below. Referring to FIGS. 3 and 4, which illustrate the third and fourth embodiments of the sound-receiving structure of the present invention, this structure is connected to two microphone units 50. In these embodiments, the number of sound inlet apertures 11, first chambers 12, water-resistant breathable filters 30, connecting passages 13, sound passages 15, and dust-proof components 40 is two, while the number of second chambers 14 is one and two, respectively. Next, referring to FIGS. 5 and 6, which illustrate the fifth and sixth embodiments of the sound-receiving structure, the main difference from the third and fourth embodiments is that the number of sound inlet apertures 11 is three, while the number of first chambers 12 and water-resistant breathable filters 30 remains one.

Through these various designs, the sound-receiving structure can effectively achieve noise reduction across different use cases without compromising sound quality. When applied to small microphone devices, as shown in FIGS. 3 and 4, the two sound inlet apertures 11 are paired with two corresponding first chambers 12, providing one-to-one filtering of external sounds for highly effective noise reduction. For enhanced filtering, as shown in FIG. 4, a larger second chamber 14 can be used to enhance the second round of noise filtering. In scenarios where more external sounds need to be received, as shown in FIGS. 5 and 6, the multiple sound inlet apertures 11 can be connected to the first chamber 12 at the same time. This many-to-one configuration allows for efficient noise filtering while accommodating a larger volume of external sound. Additionally, as mentioned above, the larger second chamber 14 shown in FIG. 5 can further enhance the noise filtering effect.

Accordingly, the sound-receiving structure of the present invention provides effective wind noise resistance by eliminating airflow noise through the larger cross-sectional area of the chambers 14 compared to the sound passage 15, and by filtering wind noise through the porous bodies 20. Since the size of the porous bodies 20 is designed to match the volume of the chambers, ensuring dimensional accuracy while minimizing material waste and reducing material costs. Additionally, the multi-chamber filtering approach further enhances the overall wind noise resistance, and the arrangement of the water-resistant breathable filter 30 and the dust-proof component 40 prevents water and dust from damaging the functionality of the porous bodies 20 and the microphone unit 50, thereby effectively extending the lifespan of the entire microphone device.

What is claimed is:

1. A sound-receiving structure, connected to at least one microphone unit, the sound-receiving structure comprising an outer shell, wherein the outer shell having:
at least one sound inlet aperture, located on the upper surface of the outer shell;
at least one chamber, situated inside the outer shell and in communication with the sound inlet aperture;
at least one porous body, placed inside the at least one chamber; and
at least one sound passage, used to connect the at least one microphone unit with the at least one chamber, wherein the cross-sectional area of the at least one sound passage is smaller than that of the at least one chamber.

2. The sound-receiving structure according to claim 1, wherein the volume of the at least one porous body is substantially equal to the volume of the at least one chamber.

3. The sound-receiving structure according to claim 2, wherein the porous bodies are made of foam, sponge, or other sound-resistant materials.

4. The sound-receiving structure according to claim 1, wherein the interior of the at least one chamber is also equipped with a water-resistant breathable filter, positioned on the side of the at least one sound inlet aperture and tightly attached to the at least one porous body.

5. The sound-receiving structure according to claim 1, wherein the at least one sound passage is equipped with a dust-proof component on one side and is tightly attached to the porous body inside the at least one chamber.

6. The sound-receiving structure according to claim 1, wherein the number of the at least one sound inlet aperture is greater than or equal to the number of the at least one chamber.

7. The sound-receiving structure according to claim 1, wherein the number of the at least one chamber is two, and the chambers are connected to each other through at least one connecting passage.
